(19) United States
(12) Patent Application Publication
(10) Pub. No.: US 2021/0329587 A1
(43) Pub. Date: Oct. 21, 2021

(54) Interference Control of Uplink Positioning

(71) Applicant: Telefonaktiebolaget LM Ericsson (publ), Stockholm (SE)

(72) Inventors: Andreas Höglund, Solna (SE); Olof Liberg, Enskede (SE); Sara Modarres Razavi, Linköping (SE)

(21) Appl. No.: 17/265,578

(22) PCT Filed: Aug. 8, 2018
(86) PCT No.: PCT/EP2018/071537

§ 371 Date: Feb. 3, 2021

(51) Int. Cl. H04W 64/00; H04W 8/24; H04W 28/02; H04W 4/80

(52) U.S. Cl. CPC H04W 64/006; H04W 4/80; H04W 28/0284; H04W 8/24

(57) ABSTRACT

The invention relates to a method for determining a location of a low power wide area device (300) connected to a cellular network. The method is carried out by a positioning node (100) and comprises the steps of receiving a positioning request for the low power wide area device (300) and selecting a first set of radio access nodes (200) of the cellular network which are available and ready to process an uplink positioning signal transmitted by the low power wide area device (300). The method further comprises the steps of requesting the low power wide area device (300) to transmit the uplink positioning signal, receiving, from the each of the first set of radio access nodes (200), a respective arrival indication comprising information as to when the uplink positioning signal was received at the respective radio access node of the first set of radio access nodes, and determining the location of the low power wide area device (300) based on the arrival indications received from at least some of the radio access nodes of the first set of radio access nodes.

### TECHNICAL FIELD

The present application relates to a method for determining a location of a low power wide area device connected to a cellular network and relates to the corresponding positioning node carrying out the method. Furthermore, a method for operating a radio access node in the cellular network is provided and the corresponding radio access node. Additionally, a method for operating the low power wide area device in the cellular network is provided and the low power wide area device. Furthermore, a system comprising the positioning node, the radio access node and/or the low power wide area device is provided. A computer program comprising program code and a carrier comprising the computer program is provided.

### BACKGROUND

Although positioning has been one of the main target study areas in mobile communication in the last decade, it still receives strong attention in recent years focusing more on the indoor users.

Nowadays, a wide range of different methods are available to estimate the position or, in other words, the location of the target user under certain circumstances. One of these methods is Uplink Time Difference of Arrival (UTDOA), which has been defined in 3GPP Release 11 for Long Term Evolution (LTE) networks. In Uplink based positioning, to estimate the location of a User Equipment (UE), the UE only needs to generate and transmit the reference signal in the uplink, i.e. in the direction from the UE to the network, and the main computational effort of time estimation, is moved from the UE towards the network side. This might be one advantage compared to Observed Time Difference of Arrival (OTDOA). In 3GPP Release 14 UTDOA was included in the work item description for the evolution of NB-IoT (Narrow Band-Internet of Things) but due to time limitations OTDOA was prioritized and UTDOA was postponed to a later release.

NB-IoT is a narrowband system developed for cellular internet of things by 3GPP. The system is based on existing LTE systems and addresses optimized network architecture and improved indoor coverage for massive number of devices with following characteristics:
low throughput devices (e.g. 2 kbps)
low delay sensitivity (˜10 seconds)
ultra-low device cost (below 5 dollars)
low device power consumption (battery life of 10 years)

It is envisioned that each cell (˜1 km²) in this system will serve thousands (50 thousand) devices such as sensors, meters, actuators, and alike. In order to be able to make use of existing spectrum for, e.g. GSM (Global System for Mobile Communications), a fairly narrow bandwidth of 180 kHz has been adopted for NB-IoT technology. The entire NB-IoT is contained within 200 kHz or one physical resource block (PRB), i.e. 12 subcarriers of 15 kHz each, in NB-IoT this is referred to as one carrier or one PRB.

In Release 13 only FDD (Frequency Division Duplex) mode of NB-IoT is standardized (i.e. the transmitter and the receiver operate at different carrier frequencies) and only half-duplex mode needs to be supported in the UE. In order to achieve improved coverage, data repetition is used both in UL (Uplink) and/or DL (Downlink, i.e. in the direction from the network to the UE). The lower complexity of the devices (e.g. only one transmission and receiver chain, respectively) means that some repetition might be needed also in normal coverage. Further, to alleviate UE complexity, the working assumption is to have cross-subframe scheduling. That is, a transmission is first scheduled on a Narrowband Physical DL Control Channel (NPDCCH) and then the first transmission of the actual data on the Narrowband Physical DL Shared Channel (NPDSCH) is carried out after the final transmission of the NPDCCH. Similarly, for uplink (UL) data transmission, information about resources scheduled by the NW (network) and needed by the UE for UL transmission is first conveyed on the NPDCCH and then the first transmission of the actual data by the UE on the Narrowband Physical UL Shared Channel (NPUSCH) is carried out after the final transmission of the NPDCCH. In other words, for both cases above, there is no simultaneous reception of control channel and reception/transmission of data channel from the UE's perspective.

Location-based services and emergency call positioning drive the development of positioning in wireless networks. For internet of things (IoT) use cases, cellular positioning is highly relevant to provide cost efficient positioning for e.g. parcel tracking. Positioning support in the Third Generation Partnership Project Long Term Evolution (3GPP LTE) was introduced in Release 9. This enables operators to retrieve position information for location-based services and to meet regulatory emergency call positioning requirements.

The following positioning techniques are considered in LTE:
Enhanced Cell ID (Identity): Essentially cell ID information to associate the UE to the serving area of a serving cell, and then additional information to determine a finer granularity position.
Assisted GNSS (Global Navigation Satellite System): GNSS information retrieved by the UE, supported by assistance information provided to the UE from a location server (i.e. E-SMLC—Enhanced-Serving Mobile Location Center).
OTDOA (Observed Time Difference of Arrival): The UE estimates the time difference of reference signals from different base stations and sends to the E-SMLC (Enhanced-Serving Mobile Location Center) for multilateration.
UTDOA (Uplink TDOA): The UE is requested to transmit a specific waveform that is detected by multiple location measurement units (e.g. an eNB—Evolved Node B) at known positions. These measurements are forwarded to E-SMLC (Enhanced-Serving Mobile Location Center) for multilateration.

To further increase the market impact of NB-IoT, improving narrowband support for positioning was agreed to be a key aspect of NB-IoT in Release 14. The enhancement was in respect to maintain the ultra-low cost and complexity of the Rel-13 NB-IoT UE where appropriate, as well as the coverage and capacity of the NB-IoT network.

In Release 14, more accurate positioning support was introduced for enhanced NB-IoT (and further enhanced LTE Machine Type Communication (MTC)) in the form of OTDOA and ECID (Enhanced Cell Identity). For OTDOA, Narrowband Positioning Reference Signals (NPRS) were introduced to provide suitable positioning accuracy for NB-IoT devices.

In later releases, Uplink Time Difference of Arrival (UTDOA) is a candidate for further extending the support for positioning in NB-IoT. In this case, positioning is instead based on the time difference of arrival of uplink signals, either the existing NPRACH or a newly introduced uplink positioning signal, which is received in multiple radio access nodes (e.g. eNBs) and used to calculate the UE positioning.

Although OTDOA and UTDOA are based on the same principle (i.e. time difference of arrival of positioning signals) the difference between the uplink and downlink in cellular networks introduces some fundamental differences. Most importantly, for OTDOA the NPRS signals are periodically broadcast in a pre-determined manner in the downlink. A drawback of this is that it will add to the system overhead since these signals will be broadcast also when not currently needed for positioning purposes (at least in the Release 13 standardized variant). Therefore, a benefit of the UTDOA is that the uplink positioning signal (e.g. NPRACH) need only be transmitted by the UE in the event its position is to be determined, hence likely to give a lower system overhead. A second benefit that the use of NPRACH can be made backwards compatible to support positioning of legacy UEs already deployed in the field. However, a serious drawback of the UTDOA is the interference between UEs. In order for UTDOA to work the uplink positioning signal has to be received in multiple radio access nodes (eNBs) and therefore a large amount of Coverage Enhancement has to be used (e.g. time repetition of the signal). This means that UEs that are otherwise well isolated in different cells will now strongly interfere with each other. If NPRACH is to be used as the uplink positioning signal in Release 15 his problem will also increase the error detection rate for Random Access attempts. Furthermore, unlike human originated traffic, machine type traffic (i.e. originated from machine devices in the Internet of Things scope) is more prone to synchronized positioning attempts since large numbers of devices in the field will be identical. This will make the above problem even more severe. Finally, the UTDOA positioning accuracy is significantly impacted by the number of UEs in one cell requiring positioning, while for a few numbers of UEs it is possible to obtain high UTDOA positioning accuracy, by adding more numbers of UEs in the same cell, the accuracy would be dramatically reduced.

### SUMMARY

Accordingly, a need exists to minimize interference in uplink positioning methods.

This need is overcome with the features of the independent claims. Further aspects are described in the dependent claims.

According to a first aspect a method for determining a location of the low power wide area device connected to a cellular network is provided. The method is carried out at a positioning node which receives a positioning request for the low power wide area device. A first set of radio access nodes of the cellular network is selected which are available and ready to process an uplink positioning signal transmitted by the low power wide area device. The positioning node furthermore requests the low power wide area device to transmit the uplink positioning signal. From each of the first set of network nodes a respective arrival indication comprising information as to when the uplink positioning signal was received at the respective network node of the first set of network nodes is received, and the location of the low power wide area device is determined based on the arrival indications received from at least some of the radio access nodes of the first set of radio access nodes.

The positioning node selects the set of radio access nodes which are able and ready to process the uplink positioning signal and as the positioning node asks the low power wide area device to transmit the uplink positioning signal the positioning node can control when the uplink positioning signal is transmitted by the low power wide area device.

A low power wide area device may denote a device allowing communications at a low bit rate and may include devices such as LTE-MTC devices, Narrow Band IoT devices, LTE-M2M, a machine to machine communication variant of a LTE etc.

Furthermore, the corresponding positioning node configured to determine the position of the low power wide area device is provided. The positioning node comprises a memory and at least one processing unit. The memory comprises instructions executable by the at least one processing unit, thereby the positioning node is operative to work as discussed above or as discussed in further detail below.

Alternatively, a positioning node is provided comprising a first module configured to receive a positioning request for the low power wide area device. The positioning node comprises a second module configured to select a first set of radio access nodes of the cellular network which are available and ready to process the uplink positioning signal transmitted by the low power wide area device. A third module of the positioning node is configured to requested the low power wide area device to transmit the uplink positioning signal and a fourth module of the positioning node is configured to receive from each of the first set of network nodes a respective arrival indication comprising information as to when the uplink positioning signal was received at the respective network node of the first set of network nodes. A fifth module of the positioning node is configured to determine the location of the low power wide area device based on the arrival indications received from at least some of the radio access nodes of the first set of radio access nodes.

According to another aspect a method for operating a radio access node in a cellular network is provided. The method comprises the step of receiving a capability request from a positioning node requesting whether the radio access node is capable of receiving and processing an uplink positioning signal transmitted from a low power wide area device. The radio access node determines whether the radio access node is capable of receiving and processing the uplink positioning signal. When the determination is in the affirmative, the radio access node transmits a confirmation to the positioning node in response to the capability request. The confirmation confirms the capability to receive and process the uplink positioning signal. Furthermore, the uplink positioning signal is received from the low power wide area device and an arrival indication is determined comprising information as to when the uplink positioning signal was received at the radio access network node. The arrival indication is transmitted to the positioning node.

The radio access node can indicate its processing capability and can inform the positioning node accordingly. It is thus known that the radio access node has the capability to receive and process the uplink positioning signal from the low power wide area device and the arrival indication is determined and transmitted to the positioning node.

Furthermore, the corresponding radio access node for the cellular network is provided. The radio access node comprises a memory and at least one processing unit. The memory comprises instructions executable by the at least one processing unit whereby the radio access node is operative to work as discussed above or as discussed in further detail below.

As an alternative a radio access node is provided which comprises a first module configured to receive the capability request from the positioning node requesting whether the radio access node is capable of receiving and processing the uplink positioning signal transmitted from the low power wide area device. The radio access node comprises a second module configured to determine whether the radio access node is capable of receiving and processing the uplink positioning signal. If this is the case, a third module is configured to transmit a confirmation to the positioning node in response to the received capability request. A fourth module of the radio access node is configured to receive the uplink positioning signal from the low power wide area device, and a fifth module of the radio access node is configured to determine an arrival indication for the uplink positioning signal and a sixth module of the radio access node is configured to transmit the arrival indication to the positioning node.

According to a further aspect a method for operating a low power wide area device in a cellular network is provided. The method comprises the step of receiving a command from a positioning node of the cellular network. The command requests an uplink transmission of an uplink positioning signal. The low power wide area device then transmits the uplink positioning signal to the radio access node of the cellular network in response to the received command.

Furthermore, the corresponding low power wide area device is provided which comprises a memory and at least one processing unit. The memory comprises instructions executable by the at least one processing unit whereby the low power wide area device is operative to work as mentioned above or as discussed in further detail below.

As an alternative, a low power wide area device located in a cellular network is provided. The device comprises a first module configured to receive a command from a positioning node of the cellular network. The command requests an uplink transmission of an uplink positioning signal. The second module of the low power wide area device is configured to transmit the uplink positioning signal to a radio access node of the cellular network in response to the received command.

The low power wide area device may be configured such that the uplink positioning signal is only transmitted upon request so that the uncontrolled transmission of positioning signals from several low power wide area devices can be avoided.

Furthermore, a system comprising at least two members from the following group of members is provided. The group comprises the positioning node as discussed above, the radio access node as discussed above and the low power wide area device as discussed above. The system comprises at least two of the three members discussed above.

Furthermore, a computer program comprising a program code to be executed by at least one processing unit of a positioning node, of a radio access node or of a low power wide area device is provided. Execution of the program code causes the at least one processing unit to execute a method as discussed above or as discussed in further detail below.

Additionally, a carrier comprising the computer program is provided. The carrier is one of an electronic signal, optical signal, radio signal, or computer readable storage medium.

It should be understood that the features mentioned above and features yet to be explained below can be used not only in the respective combinations indicated, but also in other combinations or in isolation without departing from the scope of the present invention. Features of the above-mentioned aspects and embodiments described below may be combined with each other in other embodiments unless explicitly mentioned otherwise.

### BRIEF DESCRIPTION OF THE DRAWINGS

FIG. 1 shows an example schematic architectural overview of a system in which a positioning node according to an embodiment of the invention coordinates the transmission of uplink positioning signals.

FIG. 2 shows a schematic architectural view of a cellular network in which the low power wide area devices according to embodiments of the invention and radio access nodes according to embodiments of the invention, which are shown in FIG. 1, are located.

FIG. 3 shows an example flowchart of a method carried out by the positioning node shown in FIGS. 1 and 2 for coordinating the transmission of uplink positioning signals.

FIG. 4 shows an example flowchart of a method carried out by a radio access node of FIGS. 1, 2 in a method for determining the location of a low power wide area device.

FIG. 5 shows an example flowchart of a method carried out at the low power wide area device of FIGS. 1, 2 in a coordinated transmission of uplink positioning signals.

FIG. 6 shows an example implementation of how the low power wide area device is informed by the radio access node whether an uplink positioning signal can be transmitted or not.

FIG. 7 shows a further example flowchart of a method carried out by the positioning node of FIG. 1 for coordinating the sending of the uplink positioning signal and for determining the location of the low power wide area device.

FIG. 8 shows a further example flowchart of a method carried out by the radio access node of FIG. 1, 2 in the coordinated transmission of uplink positioning signals.

FIG. 9 shows a further example flowchart of a method carried out by the low power wide area device in FIGS. 1, 2 in the coordinated transmission of uplink positioning signals.

FIG. 10 shows an example schematic representation of a positioning node according to an embodiment of the invention operative to coordinate the transmission of uplink positioning signals by the low power wide area devices.

FIG. 11 shows another example schematic representation of a positioning node according to an embodiment of the invention configured to coordinate the transmission of uplink positioning signals by low power wide area devices.

FIG. 12 shows an example schematic representation of a radio access node according to an embodiment of the invention which is operative to receive the uplink positioning signal and determine the arrival time of the uplink positioning signal.

FIG. 13 shows another example schematic representation of a radio access node according to an embodiment of the invention configured to receive the uplink positioning signal and to determine arrival time of the uplink positioning signal.

FIG. 14 shows an example schematic representation of a low power wide area device according to an embodiment of the invention operative to transmit the uplink positioning signal upon request.

FIG. 15 shows another example schematic representation of a low power wide area device according to an embodiment of the invention configured to transmit the uplink positioning signal upon request.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are illustrated such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

As will be explained below, a track control is introduced when a low power wide area device such as an NB-IoT device or an LTE/M2M device or an LTE/eMTC (enhanced Machine Type Communication) would be allowed to transmit uplink positioning signals, e.g. for UTDOA positioning. The present application allows the use of the UTDOA method even when a high number of low power wide area devices are present for which a position should be determined. It is noted that the terms “position” and “location” are used interchangeably in the present application. Furthermore, when in the following specification a UE is mentioned, it should be understood that the UE is a low power wide area device if not indicated otherwise. Such a low power wide area device may be regarded as a NB-IoT UE or a bandwidth-reduced low-complexity and/or coverage enhanced (BL/CE) LTE UE. For example, compared to a regular cellular phone used by humans, the low power wide area device operates at a greater power efficiency allowing an operation with one battery in the range of years without charging, and the transmitted data packets are small e.g. between 10 bytes and app. 1 Kbyte with transmission rates to app. 200 kbps, and the transmission distance can be greater than 1 km. As indicated above the low power wide area devices include devices such as NB-IoT devices, LTE-M devices, eMTC devices or devices operating in Long Range Wide Area Networks or Ultra-Narrow-band Modulation (UNB networks).

The UE can be a cellular phone, mobile station, laptop, notebook, notepad, tablet equipped with a wireless data connection and may be associated with non-humans like animals, plants or machines. The UE may be equipped with a subscriber identity module, SIN, which customizes the UE uniquely with a subscription.

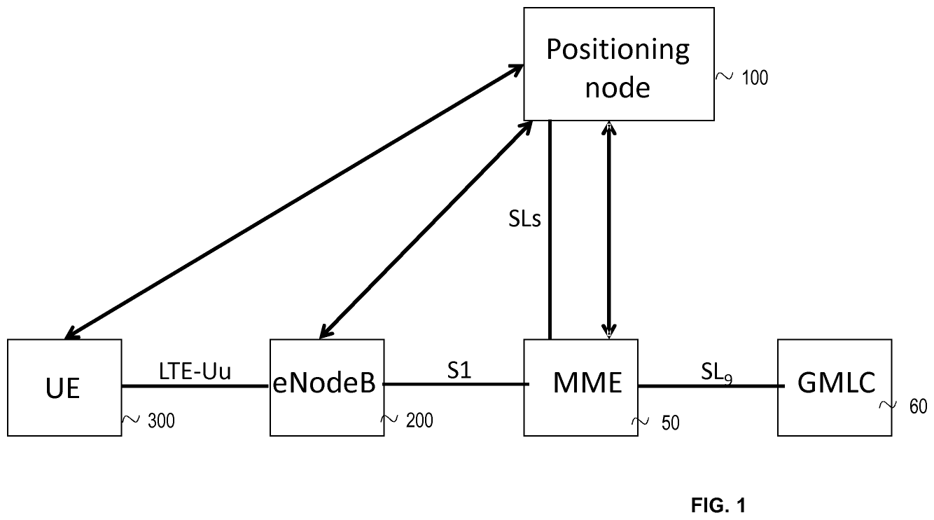

FIG. 1 shows an example schematic architectural overview in which the different entities involved in the coordinated transmission of uplink positioning signals can be implemented. A positioning node 100, also known as positioning or location server is provided which is configured to determine the location of UEs 300 which are connected to the cellular network via a radio access node 200, which in the embodiment shown is implemented as an eNodeB. The eNodeB is connected to an MME, Mobility Management Entity, 50 which is able to communicate with the positioning node, the eNodeB 200 and a gateway mobile location center, GMLC 60.

As will be explained below, an “access barring” for uplink based positioning methods is proposed in which the network such as the network shown in FIG. 1 is given control of when the UEs 300 or a plurality of UEs are allowed to transmit an uplink positioning signal based on parameters such as interference levels, cell load, etc.. The details of the solution discussed below can vary in dependence on the fact if the uplink positioning is network or UE initiated.

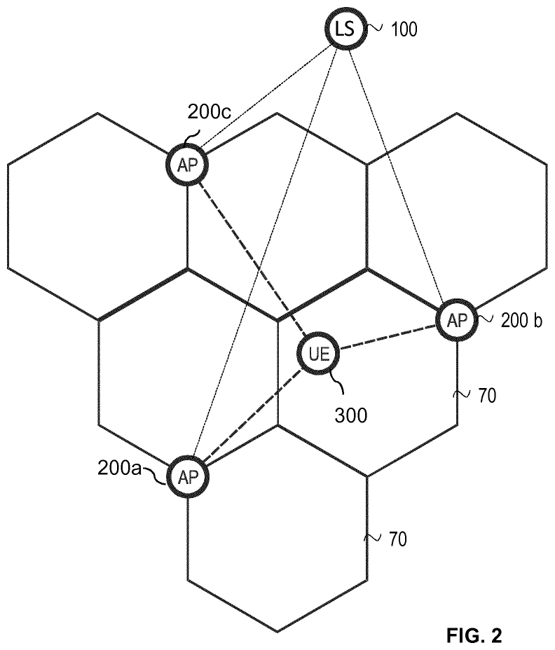

FIG. 2 shows an example schematic representation of a cellular network with several access nodes 200a, 200b and 200c which are connected to the positioning node or location server 100. Furthermore, the different cells 70 of the cellular network are shown. The positioning in a cellular network such as the network shown in FIG. 2 is possible by exploiting the characteristics of the propagating signals emitted by the UE 300. As discussed in detail in the introductory part, the time of arrival, TOA, is one possibility for determining the position of the UE 300 wherein this time of arrival is a timestamp that the receiving radio access node 200 sees on its internal clock when the uplink positioning signal is received at the corresponding node. This time of arrival is then transmitted to the positioning node 100 which based on the different time of arrivals can determine the location of the UE 300. The details of the location determination is known to the person skilled in the art and will not be explained in further detail below.

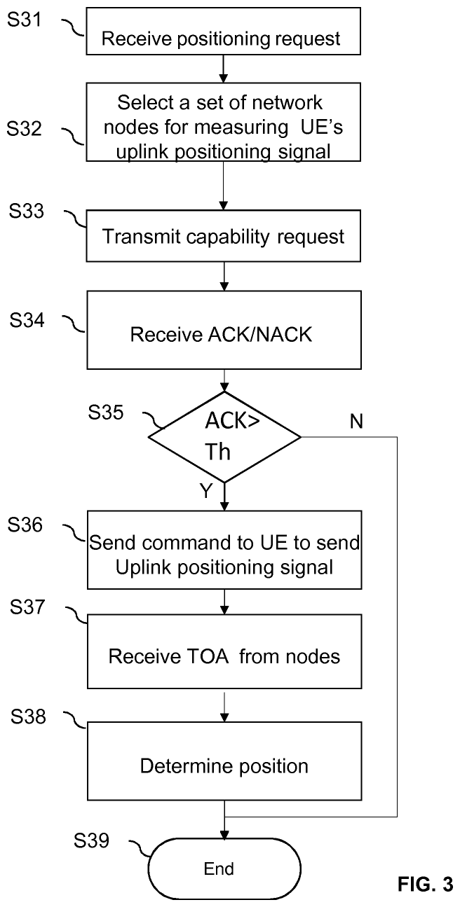

FIG. 3 summarizes some of the steps carried out at the positioning node 100. In step S31 the positioning node 100 receives the positioning request. As explained in further detail below, the positioning request mechanism may originate from the MME 50 shown in FIG. 1, the UE 300 itself or from the radio access node 200. Accordingly, the positioning node 100 receives the positioning request for one UE or low power wide area device or for a group of devices.

In step S32 the positioning node selects a first set of network nodes for measuring the UE's uplink positioning signal. In case of using an uplink reference signal for positioning purpose, the positioning node should check the congestion scenario of the radio access nodes 200, e.g.

the congestion scenario of both the reference and the neighboring cells 70 prior to the signal transmission from the UE 300. This can avoid significant interference caused by the UEs in the uplink positioning method. In step S32 the set of radio access network nodes is selected which are available and ready to process the uplink positioning signal. For selecting the set of network nodes, also named the first set of radio access nodes, a capability request is transmitted in step S33 in which radio access nodes are asked whether they can actually receive and process the uplink transmission signal from the UEs.

In step S34 the positioning node receives either the positive or negative acknowledgment (ACK/NACK) from different radio access nodes. In step S35 the positioning node can determine whether the number of radio access nodes which transmitted back a positive acknowledgment is greater than a threshold Th. By way of example this threshold number can be set to three or higher. 3 Signals are needed for a horizontal positioning, 4 signals are used for a 3 D positioning including a vertical height. For a precise positioning more signals such as 10 to 15 may be needed. The radio access nodes transmitting a positive feedback build the first set of radio access nodes.

If more positive acknowledgments are received than needed, by way of example at least three positive acknowledgments, the positioning node can send a command to the desired UE to send the uplink positioning signal (S36). The uplink positioning signal may be a newly configured uplink signal for the purpose of positioning or it may be any other already defined and used uplink signal. In step S37 the positioning node can then receive the arrival indications from the radio access nodes, by way of example the time of arrival as measured by the different radio access nodes. Based on the TOA information from the different radio access nodes the positioning node can determine the position in step S38 as it is known in the art. The method ends in step S39. If not enough positive acknowledgments are received in step S35 the positioning node can directly terminate the positioning method.

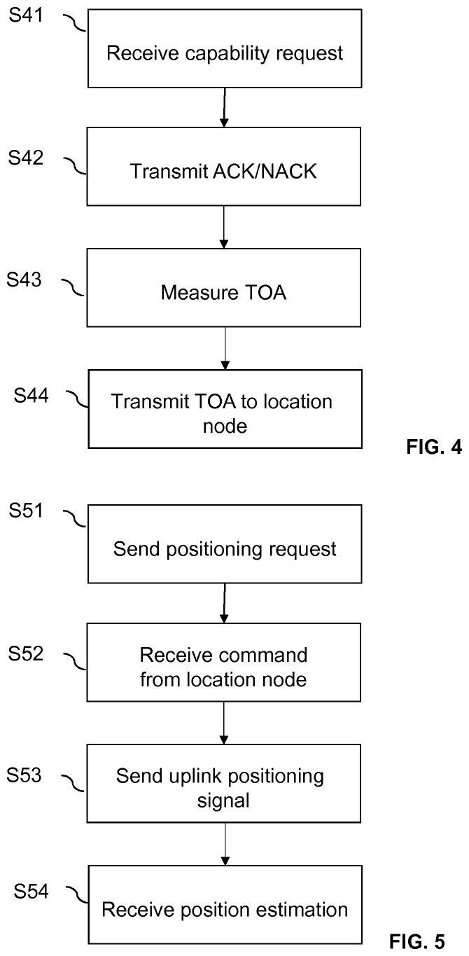

FIG. 4 summarizes the steps carried out at the radio access node in the situation discussed above. In step S41 the radio access node receives the capability request from the positioning node regarding the capability of a time of arrival measurement for the UE. In this capability request it is asked whether the corresponding radio access node is capable of receiving and processing the uplink positioning signal. The radio access node then checks its capabilities and transmits its positive or negative acknowledgment back to the positioning node (S42). In case a positive acknowledgment was sent in response to the capability request an uplink positioning signal is received in step S43 from the UE and the radio access node measures the time of arrival. The time of arrival is then transmitted in step S44 to the positioning node.

FIG. 5 summarizes some of the steps carried out at the UE 300. In step S51 the UE sends a positioning request to the positioning node. It should be understood that the request for the positioning may also come from other nodes such as the mobility managing node, MME 50 shown in FIG. 1 or from any other node in the cellular network. Accordingly, step S51 is optional. In step S52 the UE receives the request or command from the positioning node to transmit the uplink positioning signal. In step S53 the UE then sends, in response to the received request, the uplink positioning signal. As will be explained in further detail below there might be a delay between steps S52 and S53, by way of example when the UE receives the request to send the uplink positioning signal at a certain time in the future, or receives the request to send a periodic positioning signal in predefined time periods. In step S54 the UE then also receives the estimated position as estimated by the positioning node. Please note that step S54 is also optional as the UE does not necessarily receive the result of the position estimation, as this result may only be of interest to other nodes and not the UE itself.

In connection with FIGS. 3 to 5 the main steps carried out at the different entities such as the positioning node 100, the radio access node 200 or the UE 300 were discussed. In the following some of the steps discussed above and further options are discussed below.

As far as the positioning request as received by the positioning node 100 is concerned, this positioning request may be requested from the UE or it can be requested from another network node such as the MME 50. As indicated above, steps S51 and S54 are optional and would only be present in the case of a UE initiated positioning. Furthermore, it is possible that in another case of the UE initiated positioning, step S51 is omitted and the uplink positioning is granted by other means as will be explained below.

The positioning node can check which of the radio access nodes are available and ready to process the uplink positioning signal. In this context the congestion conditions of the radio access nodes can be determined. Fora certain UE 300 the positioning node 100 can consider a list of candidate reference and neighbor cells for the uplink time difference for arrival measurements. For estimating the position of one UE, at least three cells are required to hear a transmitted uplink signal. It is possible that the positioning node starts with a minimum number of cells and checks the positive or negative acknowledgement from the corresponding radio access nodes, i.e., checks the congestion situation. In case one of the cells or one of the radio access nodes sends a negative acknowledgment, another cell from a list of possible cells would be asked whether it is available and ready to process the uplink positioning signal. In a further example, the positioning node can ask the maximum number of cells, by way of example 10 cells, to respond to the capability request and in case at least three cells give a positive response, the positioning node could ask the UE for the uplink transmission. If more than the three cells or radio access nodes give a positive response, all the radio access nodes giving a positive response can be involved in the UTDOA procedure.

The radio access node would send a negative acknowledgment when it is for example congested or is not able to listen to another UE's uplink transmission. It will send a positive acknowledgment when the node is able to listen to the uplink positioning signal, an uplink reference signal of the UE.

The positioning node can also use a further procedure which is more efficient in which the request whether the radio access node is available and ready to process the uplink signal for several UEs in relation to one radio access node at the same time.

As far as the positioning node is concerned, the latter has to determine whether the positioning procedure is continued in response to the number of available radio access nodes. After receiving the positive or negative acknowledgment from the different radio access nodes, the positioning node can decide if the condition allows for continuation of the positioning procedure or not. If it is determined that the process cannot be continued a positioning request failure can be sent to the source from which the request has been received, which can be either the MME 50 or the UE 300.

The positioning node can comprise several conditions under which it refuses the continuation of the positioning process, or under which it determines to postpone it to a later time. Here the following conditions are possible:
If not minimum three cells are available to hear the UE's uplink reference signal.
If one single network node sends a NACK in case the location server sends this request to a minimum number of cells.
If the serving cell of the UE is congested and has sent a NACK.
If the geographical distance between the UE and network node sending a NACK is below a certain distance.

It is noted that refusal of the continuation process may occur if one or more or all of the above conditions are fulfilled.

In case of sufficient acknowledgement responses from the cells, the positioning node 100 can decide on the continuation of the positioning procedure and allowing the UE 300 to send an uplink transmission signal.

In the following the transmission of the uplink positioning signaled by the UE 300 is discussed in more detail below.

It has to be noted that the difference between if the network allows or commands the UE 300 to send the uplink positioning signal in step S36 and step S52 is the difference between an embodiment with access barring for UTDOA, and an embodiment with full network control (i.e. UEs 300 transmit the uplink positioning reference signal only when explicitly commanded by the network to do so). In the above example the allowance is given per positioning attempt but in an alternative example the access barring allowance could be communicated in a persistent manner (i.e. “until further notice”), for example in the form of an indication in System Information (SI) broadcast. Thereby, tedious ‘request-grant’ signaling per UTDOA attempt can be avoided (which would even if denied add to any congestion situation). That is an ‘uplink positioning reference signal’-allowed indication, which further could be differentiated by Coverage Enhancement/repetition-level, and/or given per cell 70, per UE category, per PLMN, etc. In one embodiment the allowance to transmit uplink positioning reference signal could be subject to any of the already existing access barring indications, that is Access Class Barring in SystemInformationBlockType2, Enhance Access Class Barring in SystemInformationBlockType14, NB-IoT Access Barring in in SystemInformationBlockType14-NB, etc. This could work like existing access barring. That is, the default is that uplink positioning would be allowed and only during certain shorter periods, e.g. due to congestion, high load, or high interference, it would be temporarily dis-allowed. The UE would check this flag in SI before transmitting the uplink positioning reference signal. In this embodiment some of the steps in FIG. 3, FIG. 4 and FIG. 5 would be carried out when evaluating if uplink position can be allowed in a cell, and some of the steps when a UE 300 is to transmit the uplink positioning signal, but that these would not necessarily coincide in time.

Further, the allowance to transmit uplink positioning reference signals could be coordinated between cells to suppress inter-cell interference. This could be done either on a per-cell basis, e.g. with the previously mentioned indication in System Information broadcast or according to a pre-defined time and/or frequency pattern (based on e.g. Cell_ID), or more dynamically on a per-positioning-request basis, e.g. based on all the simultaneous positioning requests in the positioning node. In yet another example this allowance could be based on the UE_ID (e.g. IMSI, S-TMSI, etc.) such that a certain UE is only allowed to transmit the uplink positioning reference signal in certain time/frequency resources, hence limiting the maximum number of simultaneously transmitted signals and therefore reducing the interference level. Concrete examples for this embodiment could be that UTDOA positioning for a UE is allowed whenever the following condition is fulfilled:
Example 1: SFN modulus UE_ID=0, where UE_ID is IMSI modulus N, and N is an integer in the range {1,2,3, . . . , 1023}. N determines the number of UE groups the UTDOA access is split in.
Example 2: (SFN+UE_ID) modulus M=0, where UE_ID is e.g. some of the most significant digits from IMSI and M is an integer which determines the number of UE groups the UTDOA access is split in.

A UE capability to transmit the uplink positioning signal would have to be introduced and communicated to the network, for example, as for other UE capabilities at initial attach procedure to the network. The capability could also be inherent from the UE category, e.g. all Rel-16 UEs could be mandated to check the allowance. The network and the location server would only pursue the above procedure for UEs indicting that capability. However, if the NPRACH is re-used as the uplink positioning signal the feature could be introduced also for UEs not implemented with the feature via the use of PDCCH order in RRC_CONNECTED or paging in RRC_IDLE.

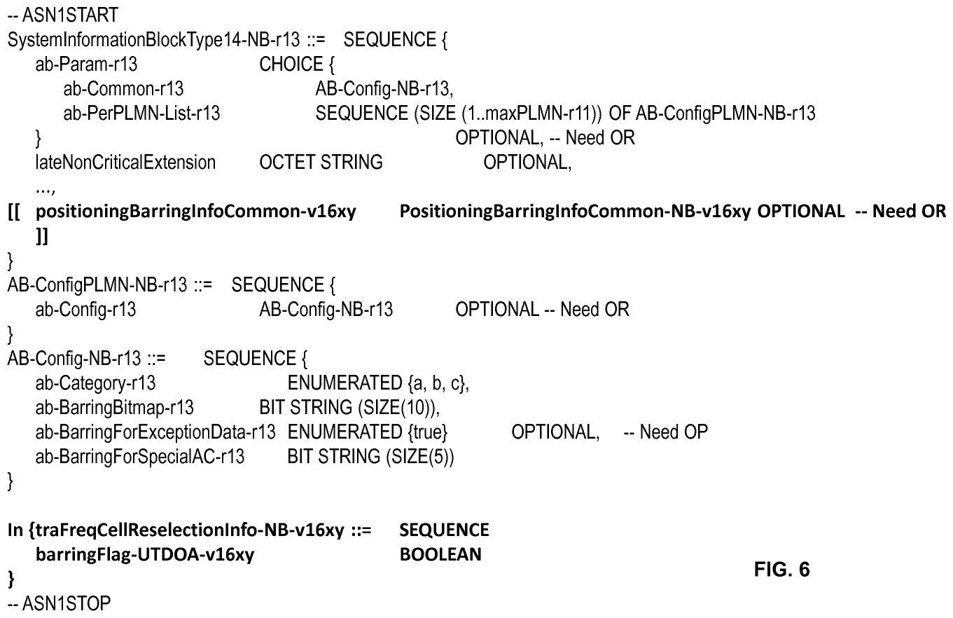

In the following different options are discussed how the UE 300 could be configured and allowed to send the uplink positioning signal requests. Each of these options can be applied individually or in combination with one or more of the other options. The different options are listed and described in the following bullet points below:
System Information (SI) signaling:(eNB↔all UEs). The ‘UTODA access barring’ can be based on cell specific measures (e.g. NPRACH load). The signaling is more long term, it can follow the existing SI update procedures, and be common to all UEs in the cell. This is sensible since it is likely not required to allow UTDOA for one UE but not for another UE in the same cell. The radio node 200 would in this example base the state of the UTDOA barring flag on known radio conditions in the current cell, e.g. NPRACH load and available resources, and possible input from the positioning node, e.g. interference and load of positioning in multiple cells. Including the UTDOA barring flag in any of the regular SystemInformationBlockTypes (SIBs) can be somewhat slow when enabling the barring since SI update of these are done according to the SI modification period. Therefore, one implementation could be to add the UTDOA barring flag to SystemInformationBlockType14-NB which have to be read by UEs prior to access. A proposal on how this could be implemented in 3GPP Release 16 is given in FIG. 6. For any non-dynamic configuration, like UTDOA barring based on_ID, would be more suitable to add the information to any of the regular SIBs.
NAS (Non Access Stratum) signaling: (MME↔UE) The NAS signaling alternative is suitable since positioning involves more than the current cell of the UE and the UE configuration naturally applies to an entire tracking area and not just the current cell (as the RRC (Radio Resource Control) alternative below). However, the signaling is not very dynamic, it requires either a tracking area update (TAU) or a EMM (EPS Mobility Management) connection, to change the UTDOA allowance of the UE. Therefore, it is less suitable for quickly resolving e.g. a congestion situation but more suitable for long-term configuration of e.g. UTDOA barring based on UE_ID.
RRC signaling: (eNB↔UE) This alternative can make sense for stationary UEs which remain in the same cell. Further, as for the previous alternative, since the signaling is not very dynamic (it requires a connection to eNB), this is most suitable for configuration, e.g. of UTDOA barring based on UE_ID. Any RRC configuration received would only be applicable to the UE during the ongoing RRC connection and released when the UE moves to RRC_IDLE, if it is desired that the UE continues to apply the configuration after it moves to RRC_IDLE, the RRC configuration can be made “sticky” such that would apply in the current cell until further notice.
LPP (LTE Positioning Protocol) signaling: (location server↔UE) In this alternative the configuration of the UE would be added to existing LPP signaling. Since it requires that a connection is set up to the UE it, like the previous two solutions, is more suitable for long-term configuration which does not require dynamic changes. That said, it is a natural candidate for additions of positioning related signaling. Configuration for interference coordination can be either transferred from eNB to the location server by LPPa (LTE Positining Protocol A) protocol and informed to the UE via LPP, or it can be directly provided to the UE from the eNB via RRC.

In an alternative example of the UTDOA allowance can be configured per cell and coordinated between cells to minimize the inter-cell interference. This can be, by way of example achieved by any of the following options which can be applied individually or in any arbitrary combination:
Time division between cells: Time periods are configured during which UEs 300 are allowed to transmit uplink positioning reference signals. The time periods would be different in neighboring cells in a frequency reuse manner to achieve inter-cell interference reduction. The time period could e.g. be certain system frame numbers (SFNs). One way to formalize this could be that when

(PCID+SFN) modulus n=0

is fulfilled, transmission of uplink positioning reference signals would be allowed in a cell. (Here where PCID is the physical cell identity of the cell and n is an integer giving the amount of “frequency reuse”, i.e. if n=2 a given cell would be allowed in every other radio frame and cells with odd and even PCID would be shifted in time). Another example would be that UTDOA access is allowed in a cell when the following condition is fulfilled:

SFN modulus Cell_ID=0

where Cell_ID is PCID modulus K, and K is an integer in the range {1,2,3, . . . , 1023}. K determines the number of cells the UTDOA access is split in.

Other time periods that could be used could be Hyper-SFN, time periods based on absolute time (e.g. from SIB (System Information Block) 8), etc. Using repetitions for coverage enhancement, a sensible adoption would be that UTODA is allowed or not depending on if the starting point of the time repetitions lies within the above time period or not.
Time offset: When resources for UTDOA (or NPRACH) are configured, a time offset, which is different between cells, is applied to avoid overlapping resources and inter-cell interference in neighboring cells.
Frequency multiplexing: Different cells could use different resources in the frequency domain to avoid inter-cell interference. However, positioning is more accurate the more wideband the positioning signal is so this alternative has certain drawbacks.

The solutions listed above would typically be pre-configured such that no additional signaling would be required per UTDOA attempt. The configuration could be done by e.g. SI, RRC (Radio Resource Control), NAS, or LPP.

As far as the position estimation itself is concerned when the UE 300 sends the uplink positioning signal, the network nodes which have already acknowledged the measurement, do the time of arrival measurements and send them to the positioning node in which the position of the UE 300 is computed by multilateration techniques.

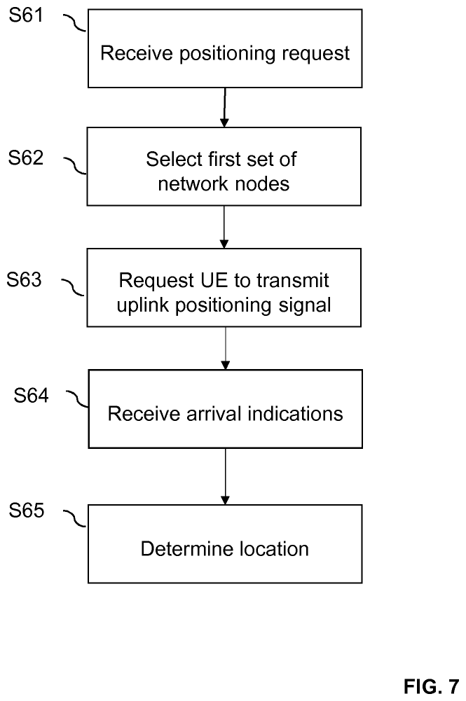

FIG. 7 summarizes some of the relevant steps carried out by the positioning node 100 in the embodiments discussed above.

In step S61 the positioning node 100 receives the positioning request in which it is requested to determine a position of a UE/low power wide area device. In step S62 the positioning node 100 selects a first set of radio access nodes 200 of the cellular network which are available and ready to process the uplink positioning signal transmitted by the UE. As indicated above, different options exist to select the first set of radio access nodes. When enough radio access nodes are available and selected the positioning node 100 requests the UE 300 to transmit the uplink positioning signal. In step S64 the positioning node receives from the different radio access nodes an arrival indication comprising the information as to when the uplink positioning signal was received at the corresponding radio access node 200. Based on the received arrival indications, the time of arrival, received from the different radio access nodes the positioning node can determine the location of the UE 300.

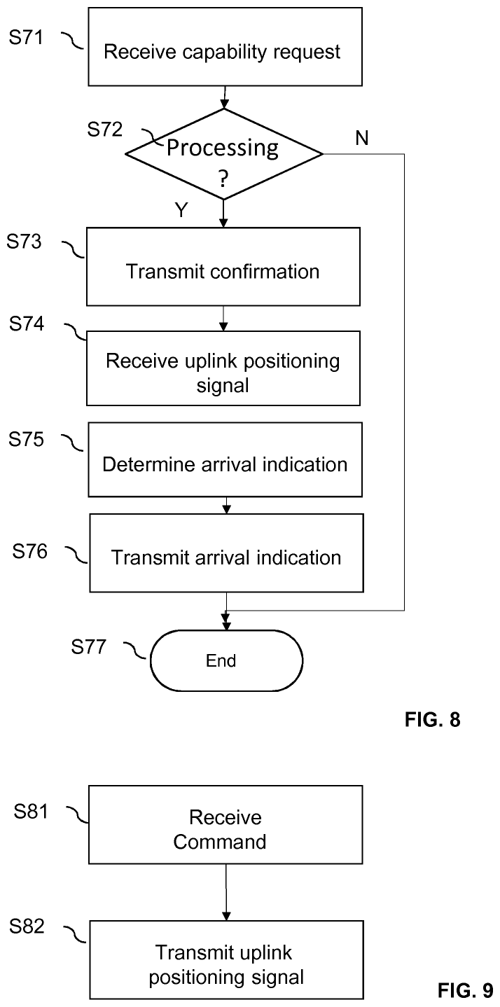

FIG. 8 summarizes some of the relevant steps of the radio access node 200 in the method discussed above. In step S71 the radio access node receives the capability request in which the radio access node is requested whether it is capable of receiving and processing the uplink positioning signal. In step S72 the radio access node then checks its capability. If the radio access node is capable of receiving and processing the uplink positioning signal, it transmits a confirmation in step S73 to the positioning node in response to the received capability request of step S71. As the positioning node can then inform the UE 300 to send the uplink positioning signal, the radio access node will then receive the uplink positioning signal in step S74 and will determine the arrival indication in step S75. The determined time of arrival is then transmitted in step S76 to the positioning node 100. The method ends in step S77. If it is determined in step S72 that the capability is not available at the radio access node, the process can end, by way of example with the sending of a negative acknowledgement.

FIG. 9 summarizes some of the relevant steps carried out at the UE 300 itself. In step S81 the UE receives the command to transmit the uplink positioning signal. In step S82 the UE then transmits the uplink positioning signal in response to the command. As indicated above, there might be a time delay between steps S81 and S82 depending on the kind of command received in step S81.

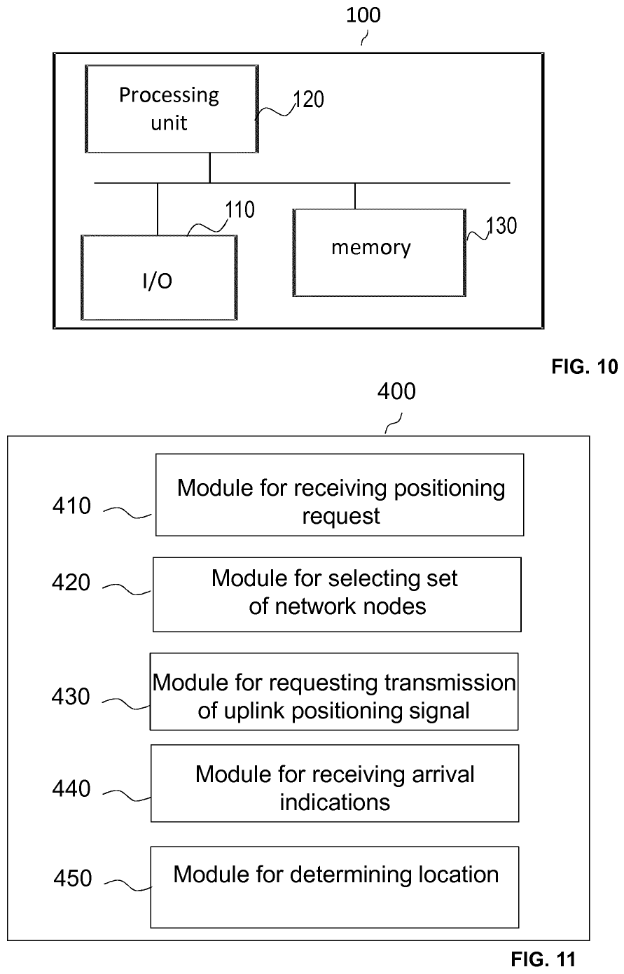

FIG. 10 shows a schematic architectural view of the positioning node 100 which can carry out the above discussed calculation of the positioning. The positioning node 100 comprises an interface or input/output unit 110 which is provided for transmitting user data or control messages to other entities and for receiving user data or control messages from other entities. The input/output 110 may be configured to receive the positioning request, to request the UE to transmit the uplink positioning signal and to receive the information about the time of arrivals transmitted by the UE 300.

The positioning node 100 furthermore comprises a processing unit 120 which is responsible for the operation of the positioning node 100. The processing unit 120 can comprise one or more processors and can carry out instructions stored on a memory 130, wherein the memory may include a read-only memory, a mass storage, a random access memory, a hard disk or the like. The memory can furthermore include a suitable program code to be executed by the processing unit 120 so as to implement the above described functionalities in which the positioning node is involved. The processing of 120 can especially be configured to control and coordinate the transmission of the uplink positioning sequence as discussed above.

FIG. 11 shows an alternative schematic view of a positioning node 400 which comprises a first module 410 configured to receive the positioning request for the UE 300. The node 400 comprises a second module 420 configured to select the first set of radio access nodes which should receive the uplink positioning signal and which are available and ready to process the uplink positioning signal. A module 430 is provided configured to request the transmission of the uplink positioning signal from the selected UE 300 and a module 440 is provided configured to receive the different arrival indications received from the different radio access nodes 200. Furthermore, a module 450 is provided for determining the location of the UE 300 based on the received arrival indications.

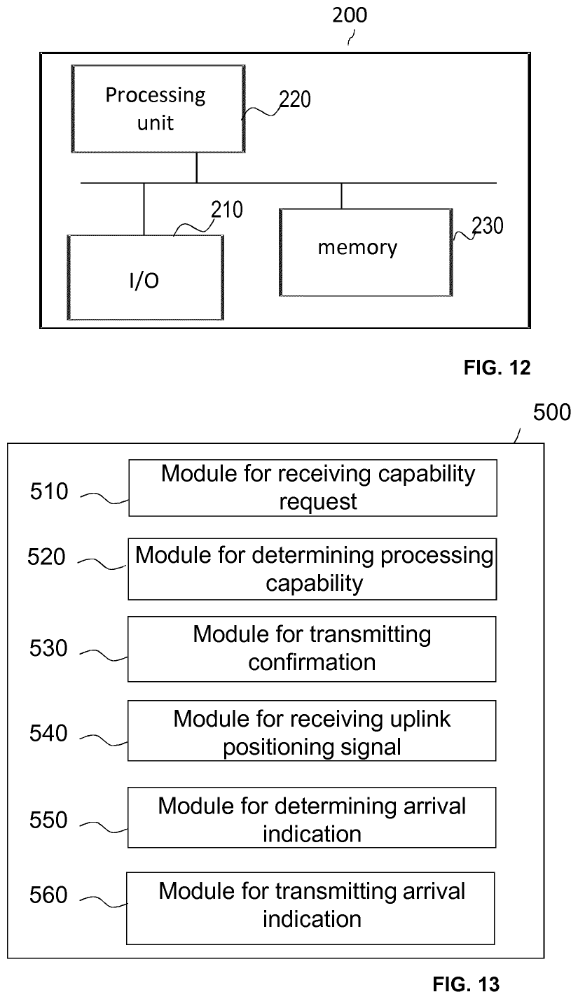

FIG. 12 shows a schematic architectural view of a radio access node 200 which can carry out the above discussed steps in which the radio access node is involved. The node 200 comprises an input/output or interface 210 configured to receive user data and control messages and configured to transmit user data or control messages. The input/output 210 can be specially configured to receive the uplink positioning signal and to transmit the information of the time of arrival of the uplink positioning signal to the positioning node 100. The radio access node 200 furthermore comprises a processing unit 220 which is responsible for the operation of the radio access node 200. The processing unit 220 can comprise one or more processors and can carry out instructions stored on a memory 230, wherein the memory may include a read-only memory, a random access memory, a mass storage, a hard disk, or the like. The memory can furthermore include a suitable program code to be executed by the processing unit 220 so as to implement the above described functionalities in which the radio access node 200 is involved.

FIG. 13 shows a further schematic architectural view of a radio access node 500 which can carry out the above discussed steps in which the radio access node is involved. The radio access node comprises a first module 510 configured to receive the capability request from the positioning node 100 in which it is requested whether the radio access node is capable of receiving and processing the uplink positioning signal. A further module 520 is configured to determine the processing capability, whether it is capable of receiving and processing the uplink positioning signal. A module 530 is provided which is configured to transmit a confirmation to the positioning node in response to the received capability request when module 520 determines that the processing capability is available. A module 540 is provided for receiving the uplink positioning signal from the UE 300 and a module 550 is provided configured to determine the time of arrival of the uplink positioning signal. The module 560 is provided for transmitting the determined arrival indication comprising the time of arrival to the positioning node.

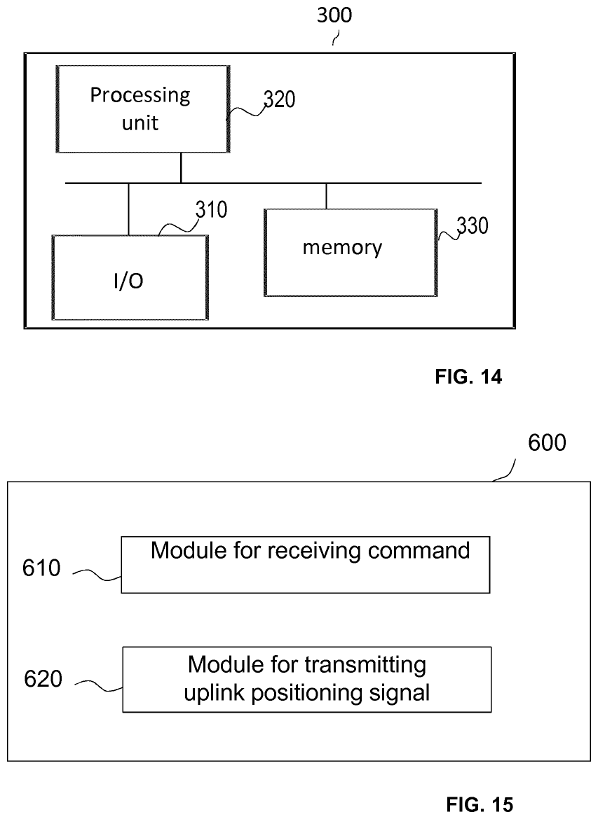

FIG. 14 shows a schematic architectural view of a UE or low power wide area device 300 which comprises an input/output or interface 310 configured to transmit user data or control messages to the other entities involved and configured to receive user data and control messages from other entities. The input/output 310 is especially configured to receive the command in which it is requested to transmit the uplink positioning signal, wherein the input/output 310 is configured to transmit the uplink positioning signal upon request. The device 300 comprises a processing unit 320 which is responsible for the operation of the device 300. The processing unit 320 comprises one or more processors and can carry out instructions stored on a memory 330, wherein the memory may include a read-only memory, a random access memory, a mass storage, a hard disk or the like. The memory can furthermore include a suitable program code to be executed by the processing unit 320 so as to implement the above described functionalities in which the device 300 is involved.

FIG. 15 shows another schematic architectural view of a low power wide area device with a first module 610 configured to receive the command for the transmission of the uplink positioning signal. A second module 620 is provided configured to transmit the uplink positioning signal upon request.

From the above discussion of the different examples some general conclusions can be drawn: As far as the positioning node 100 is concerned, different options exist to select the first set of radio access nodes which are available and ready to process the uplink positioning signal. The step of selecting this first set of radio access nodes can comprise the step of selecting a second set of radio access nodes of the cellular network which should process the uplink positioning signal. It is then determined which of the radio access nodes of the second set of radio access nodes are available and ready to process the uplink positioning signal. The first set of radio access nodes then comprises the radio access nodes from the second set of radio access nodes for which it is confirmed that they are available and ready to process the uplink positioning signal.

For determining which of the radio access nodes are available it is possible to transmit a capability request to each access node of the second set of radio access nodes as to whether the respective radio access node of the second set of radio access nodes is capable of receiving and processing the uplink positioning signal. It is furthermore determined for which of the radio access nodes of the second set of nodes a positive confirmation is received in response to the transmitted capability request. The first set of radio access nodes then comprises all the radio access nodes for which a positive confirmation is received.

Furthermore, it is possible that the second set of radio access nodes is selected from a list of radio access nodes. When it is determined that one of the radio access nodes of the second set of radio access nodes is not available and ready to process the uplink positioning signal, a further radio access node present in the list is selected, and it is determined whether this further radio access node is available and ready to process the uplink positioning signal.

In this context the second set of radio access nodes can comprise a larger number of radio access nodes that the first set of radio access nodes. The step of requesting the low power wide area device to transmit the uplink positioning signal can only be carried out when it is determined that a predefined number of radio access nodes, e.g. three nodes, from the second set of radio access nodes is available and ready to process the uplink positioning signal.

The positioning node can further determine whether a predefined condition has been met for the first set of radio access nodes. When the predefined condition is not met, the low power wide area device is not requested to send the uplink positioning signal and a failure message can be sent in response to the received positioning request, wherein the failure message indicates that the location of the low power wide area device is not determined. One condition can be the minimum number of radio access nodes for which it is confirmed that they are available and ready to process the uplink positioning signal. The low power wide area device can only be requested to transmit the uplink positioning signal when the minimum number of radio access nodes is above a predefined threshold. This was discussed in further detail above in connection with step S35.

Furthermore, it is possible that the positioning request is received from the mobility managing node such as the MME 50 or from the low power wide area device 300 itself.

When the low power wide area device is requested to transmit the uplink positioning signal, the low power wide area device can be informed that the transmission of the uplink positioning signal is allowed as long as no indication is received indicating to the low power wide area device that it should stop transmitting the uplink positioning signal.

Furthermore, it is possible that the positioning node determines a level of congestion of a reference cell in which the low power wide area device is located and of some of the neighboring cells of the reference cell.

When the positioning node requests the low power wide area device to transmit the uplink positioning signal, it can inform the low power wide area device of a transmission resource which should be used for the transmission of the uplink positioning signal. Furthermore, it is possible that a group of low power wide area devices is determined which should transmit the uplink positioning signal. Furthermore, a device information can be encoded into a request broadcast to a plurality of low power wide area devices, wherein the encoded device information allows the identification of each member of the group.

As discussed above in this embodiment a plurality of UEs 300 are informed to send the uplink positioning signal.

The positioning node can determine the location of the low power wide area device based on an observed time difference of arrival of the different arrival indications received from the first set of radio access nodes.

As far as the radio access node 200 itself is concerned, the radio access node determines whether it is capable of receiving and processing the uplink positioning signal. To this end it can determine an operating condition of the radio access node and can determine based on the operating condition whether it is capable of receiving the uplink positioning signal.

When the operating condition is determined, this can mean that it is determined whether the radio access node is able to listen to the uplink positioning signal to be transmitted by the low power wide area device. When the radio access node is able to listen to the uplink positioning signal the positioning node is informed accordingly.

However, when it is determined that the radio access node 200 is not able to listen to the uplink positioning signal, the low power wide area device is informed of this fact. This fact may be encoded into a system information broadcast by the radio access network node, e.g. as shown in FIG. 6.

When it is determined that the radio access node is not capable of receiving and processing the uplink positioning signal, the positioning node is informed that the radio access node is not capable of receiving and processing the uplink positioning signal.

As far as to low power wide area device itself is concerned, the device can transmit a positioning request to the positioning node 100 in order to initiate the procedure. Furthermore, it is possible that the device 300 also receives the position information comprising the location of the low power wide area device from the positioning node.

When the device receives the command to transmit the uplink positioning signal, the received command can comprise an indication of how future uplink positioning signals should be transmitted, wherein the uplink positioning signal is transmitted after receiving the command taking into account the received indication. By way of example the command can be sent once with a time indicating the validity of the frame in which the device can send an uplink signal or even a number of different transmissions.

The received command can be encoded into a system information received at the low power wide area device. Here the device 300 can decode from the received system information that the low power wide area device should transmit the uplink positioning signal wherein the uplink positioning signal is transmitted in response to the decoding.

Furthermore, the device 300 can determine a transmission resource from the received command which is to be used for the transmission of the uplink positioning signal, wherein the uplink positioning signal is then transmitted in the determined transmission resource.

The command can be a broadcast message for a plurality of low power wide area devices, wherein the broadcast message comprises encoded device information allowing a group of low power wide area devices which should transmit the uplink positioning signal to be identified. The uplink positioning signal is then only transmitted when the device determines from the encoded device information that it is a member of the group.

The above discussed situation has several advantages:

first of all it ensures a proper positioning performance for UTDOA wherein the negative impact of interference is controllable. Furthermore, it provides a positioning support to a large number of UEs in the same cell. It introduces a network control for the negative impact of UTDOA on the random access procedure if NPRACH is used as an uplink positioning signal. Furthermore, it ensures a long battery life of the UEs since every attempt at high coverage enhancement level means a long transmission time and is thus very power consuming.

1-53. (canceled)

54. A method for determining a location of a low power wide area device connected to a cellular network, the method comprising a positioning node:
receiving a positioning request for the low power wide area device;
determxining a level of congestion of a reference cell in which the low power wide area device is located and of neighboring cells of the reference cell;
selecting a first set of radio access nodes of the cellular network which are available and ready to process an uplink positioning signal transmitted by the low power wide area device based on the determined level of congestion;
requesting the low power wide area device to transmit the uplink positioning signal;
receiving, from the each of the first set of radio access nodes, a respective arrival indication comprising information as to when the uplink positioning signal was received at the respective radio access node of the first set of radio access nodes; and
determining the location of the low power wide area device based on the arrival indications received from at least some of the radio access nodes of the first set of radio access nodes.

55. The method of claim 54, wherein the selecting the first set of radio access nodes comprises:
selecting a second set of radio access nodes of the cellular network which should process the uplink positioning signal;
determining which of the radio access nodes of the second set of radio access nodes are available and ready to process the uplink positioning signal;
wherein the first set of radio access nodes comprises the radio access nodes from the second set of radio access nodes for which it is confirmed that these radio access nodes are available and ready to process the uplink positioning signal.

56. The method of claim 55, wherein the determining which of the radio access nodes of the second set of radio access nodes are available comprises:
transmitting a capability request to each radio access node of the second set of radio access nodes as to whether the respective radio access node of the second set of radio access nodes is capable of receiving and processing the uplink positioning signal;
determining for which of the radio access nodes of the second set of radio access nodes a positive confirmation is received in response to the transmitted capability request;
wherein the first set of radio access nodes comprises all the radio access nodes for which a positive confirmation is received.

57. The method of claim 55:
wherein the second set of radio access nodes is selected from a list of radio access nodes;
wherein, in response to determining that one of the radio access nodes of the second set of radio access nodes is not available and ready to process the uplink positioning signal, a further radio access node present in the list of radio access nodes is selected, and it is determined whether the further radio access node is available and ready to process the uplink positioning signal.

58. The method of claim 55:
wherein the second set of radio access nodes comprises a larger number of radio access nodes than the first set of radio access nodes;
wherein requesting the low power wide area device to transmit the uplink positioning signal is only carried out when it is determined that a predefined number of radio access nodes from the second set of radio access nodes is available and ready to process the uplink positioning signal.

59. The method of claim 55:
further comprising determining whether a predefined condition has been met for the first set of radio access nodes;
wherein when the predefined condition is not met:
the low power wide area device is not requested to send the uplink positioning signal; and
a failure message is sent in response to the received positioning request, the failure message indicating that the location of the low power wide area device is not determined.

60. The method of claim 59:
wherein the predefined condition comprises a minimum number of radio access nodes for which it is confirmed that these radio access nodes are available and ready to process the uplink positioning signal;
wherein the low power wide area device is only requested to transmit the uplink positioning signal when the minimum number of radio access nodes is above a predefined threshold.

61. The method of claim 54, wherein the positioning request is received from a mobility managing node of the cellular network and/or the low power wide area device.

62. The method of claim 54, wherein the requesting the low power wide area device to transmit the uplink positioning signal comprises informing the low power wide area device that the transmission of the uplink positioning signal is allowed as long as no indication is received indicating to the low power wide area device that it should stop transmitting the uplink positioning signal.

63. The method of claim 54, wherein the requesting the low power wide area device to transmit the uplink positioning signal comprises:
informing the low power wide area device of a transmission resource to be used for the transmission of the uplink positioning signal; and/or
determining a group of low power wide area devices which should transmit the uplink positioning signal, and encoding device information into a request broadcast to a plurality of low power wide area devices which information allows identification of each member of the group.

64. The method of claim 54, wherein the location of the low power wide area device is determined based on an observed time difference of arrival of the different arrival indications received from the first set of radio access nodes.

65. A method for operating a radio access node in a cellular network, the method comprising:
receiving, from a positioning node, a capability request requesting whether the radio access node is capable of receiving and processing an uplink positioning signal transmitted from a low power wide area device;
determining whether the radio access node is capable of receiving and processing the uplink positioning signal;
in response to the determination being in the affirmative:
transmitting a confirmation to the positioning node in response to the capability request, the confirmation confirming the capability to receive and process the uplink positioning signal;
receiving the uplink positioning signal from the low power wide area device;
determining an arrival indication comprising information as to when the uplink positioning signal was received at the radio access radio access node; and
transmitting the arrival indication to the positioning node;
wherein the determining whether the radio access node is capable of receiving and processing the uplink positioning signal comprises:
determining an operating condition of the radio access node; and
determining, based on the operating condition, whether the radio access node is capable of receiving the uplink positioning signal;
wherein the determining the operating condition comprises determining whether the radio access node is able to listen to the uplink positioning signal to be transmitted by the low power wide area device; wherein, when the radio access node is able to listen to the uplink positioning signal, the positioning node is informed accordingly.

66. The method of claim 65 wherein, when it is determined that the radio access node is not able to listen to the uplink positioning signal, the low power wide area device is informed of this fact.

67. The method of claim 66, wherein the fact is encoded into a system information broadcast by the radio access radio access node.

68. The method of claim 65, wherein, when it is determined that the radio access node is not capable of receiving and processing the uplink positioning signal, the positioning node is informed that the radio access node is not capable of receiving and processing the uplink positioning signal.

69. A positioning node configured to determine a position of a low power wide area device connected to a cellular network, the positioning node comprising:
processing circuitry;
memory containing instructions executable by the processing circuitry whereby the positioning node is operative to:
receive a positioning request for the low power wide area device;
determine a level of congestion of a reference cell in which the low power wide area device is located and of neighboring cells of the reference cell;
select a first set of radio access nodes of the cellular network which are available and ready to process an uplink positioning signal transmitted by the low power wide area device based on the determined level of congestion;
request the low power wide area device to transmit the uplink positioning signal;
receive, from the each of the first set of radio access nodes, a respective arrival indication comprising information as to when the uplink positioning signal was received at the respective radio access node of the first set of radio access nodes; and
determine the location of the low power wide area device based on the arrival indications received from at least some of the radio access nodes of the first set of radio access nodes.

70. A radio access node for a cellular network, the radio access node comprising:
processing circuitry;
memory containing instructions executable by the processing circuitry whereby the radio access node is operative to:
receive, from a positioning node, a capability request requesting whether the radio access node is capable of receiving and processing an uplink positioning signal transmitted from a low power wide area device;
determine whether the radio access node is capable of receiving and processing the uplink positioning signal;
in response to the determination being in the affirmative:
transmit a confirmation to the positioning node in response to the capability request, the confirmation confirming the capability to receive and process the uplink positioning signal;
receive the uplink positioning signal from the low power wide area device;
determine an arrival indication comprising information as to when the uplink positioning signal was received at the radio access radio access node; and
transmit the arrival indication to the positioning node;
wherein the determining whether the radio access node is capable of receiving and processing the uplink positioning signal comprises:
determining an operating condition of the radio access node; and
determining, based on the operating condition, whether the radio access node is capable of receiving the uplink positioning signal;
wherein the determining the operating condition comprises determining whether the radio access node is able to listen to the uplink positioning signal to be transmitted by the low power wide area device; wherein, when the radio access node is able to listen to the uplink positioning signal, the positioning node is informed accordingly.
